(19) United States
(12) Patent Application Publication
(10) Pub. No.: US 2018/0081419 A1
(43) Pub. Date: Mar. 22, 2018

(54) Methods for Power Characterization by Control State in System Analysis

(71) Applicant: Ninad Huilgol, Fremont, CA (US)

(72) Inventor: Ninad Huilgol, Fremont, CA (US)

(21) Appl. No.: 15/268,580

(22) Filed: Sep. 17, 2016

(51) Int. Cl. G06F 1/32

(52) U.S. Cl. CPC G06F 1/3287

(57) ABSTRACT

A system simulation estimates power consumption based on only the control portion of the input stimuli for the system.

### PRIORITY

This application claims the priority of PPA 62/233,337.

### FIELD OF INVENTION

This pertains to the field of power estimation in the field of system-level simulation of digital electronic and digital electromechanical systems in engineering.

### BACKGROUND

Today before building many kinds of systems in it is quite important to simulate such a system to determine how much power it will consume.

The faster and earlier the designers understand how a system they are designing consumes power, the better off they are, since they can redesign, optimize or otherwise change the system at a lower cost in time and expenditure.

The very earliest time to analyze a system's power consumption is when the designers have fully described the system as a set of models. The designers can perform a mathematical analysis of the models themselves to estimate what they think the minimum, maximum and typical power consumption will be. This technique is called static analysis. It can be useful as a very fast estimate of system power consumption. But it is clumsy in many ways. E.g. the maximum power consumption static analysis claims a system will reach, may actually be impossible because it addresses a situation where two pieces of the system which would never run concurrently in real life, both expend power.

So the typical method to understand system power consumption is dynamic analysis or simulation. Here a simulator runs a computer model of the system over time. The simulator feeds stimuli to the system—these stimuli are called input vectors. Each input vector feeds all of the inputs of the system. The simulation feeds a sequence of input vectors into the model of the system as it simulates the system over time.

Such stimuli may come from diverse sources, e.g. they may be handcrafted, they may be randomly generated, or they may be drawn from empirical data.

The simulation determines how the system broadly behaves with these stimuli. In particular the simulation estimates, based on models for each component of the system, how much power each component consumes for a given set of stimuli. From this the simulation estimates how much power the system consumes as a whole for a given set of stimuli.

Prior Art

| PPA/RPA/US Patent | Author |
|---|---|
| U.S. Pat. No. 7,882,458 | Tamaki |
| U.S. Pat. No. 7,900,172 | Niitsuma et al. |
| U.S. Pat. No. 8,612,911 | Buechner et al. |
| U.S. Pat. No. 9,141,734 | Huilgol |
| U.S. Pat. No. 9,330,425 | Boss et al. |
| PPA 62/220,703 | Huilgol |

Tamaki teaches saving characterizing power analysis based on circuitry and transistor models, and computing power consumption by counting transistors and gates thus modeled.

Niitsuma et al. teaches measuring power consumption by determining when a block operates or not.

Buechner et al. teaches determining an upper bound on the power consumption of a given gate by static timing analysis.

Huilgol (U.S. Pat. No. 9,141,734) teaches estimating power consumption by characterizing each block for power consumption and simulating these blocks together.

Boss et al. teaches saving power consumption data in a database, generating a load usage prediction report, and analyzing that report.

Huilgol) PPA 62/220,713) teaches methods which simulates a system by providing it input stimulus vectors and then estimating its power consumption based on those vectors. This method first determines a power consumption characterization model for each element of the system for each potential input vector of stimulus. It from a plurality of methods which include the following:
Mathematically calculating how much power the element uses based on some description of the composition of the element plus the values of the input vector
Simulating the element and seeing what the simulation estimates power consumption to be for the element
Empirically driving the input vector of the stimulus into a real implementation of the system element and determining how much power the system element uses

This is a good starting point since it provides power estimation where no such power estimation was available before. However it is inefficient since the input vectors are often very large.

### MOTIVATION FOR THE INVENTION

Logically one may distinguish the signals coming into a system, or for that matter into any sub-block of a system, into control signals and data signals. Data signals carry the information upon which the system performs operations. Control signals configure the system itself.

Examples of control signals going into a block include:
Signals which control starting, stopping and the rate of data flow into, through, and out of the block
Clocks and resets going into the block

Examples of data signals going into a block include the data flowing into the block itself.

Further analysis reveals that in general in such cases if one divides the input stimuli into control and data signals then:
1. There are very few control signals and the vast majority of signals are data signals.
2. The power consumption of the system is almost entirely a function of the values of the control signals and not a function of the values of the data signals.
3. The system consumes power almost entirely in the data path. It consumes very little power in the control path.
4. Data signal variations tend to be random and cannot be predicted accurately in system simulation. Control signals in contrast tend to be fairly predictable.

Thus using only the values control signals for estimating power consumption would allow for simulating with only a fraction of the overall signals in the input vectors. Since simulation cost in computation time is a factor of the number of input vectors simulated this would provide for estimating power consumption in a fraction of the computation time in relation to using all input signals.

### SUMMARY OF THE INVENTION

The present invention teaches methods to perform system-level estimation of power consumption through simulation using input vectors of stimuli. The improvement over prior methods is the present methods separate these input vectors into control and data signals, and then estimate power only as a function of the control signals acting as input for each component of the system. Before this is done each component has been characterized with regard to average power usage for any particular value of control inputs. This characterization plus the current control values during simulation determine the power consumption estimate for that component, and summing these generates the overall power consumption estimate for the system at a given time.

### DIFFERENTIATION OVER PRIOR ART

In all cases Prior Art uses all signals, both control and data, to characterize power consumption. The present invention teaches using only control signals to characterize power consumption.

### BRIEF DESCRIPTION OF THE DRAWINGS

FIG. 1 shows how data flow may happen due to different control signal settings. It shows three different possible ways a system may consume power based on data. In all three cases—shown by graphs—the horizontal axis (101) shows the progression of time and the vertical axis (102) shows data flow.

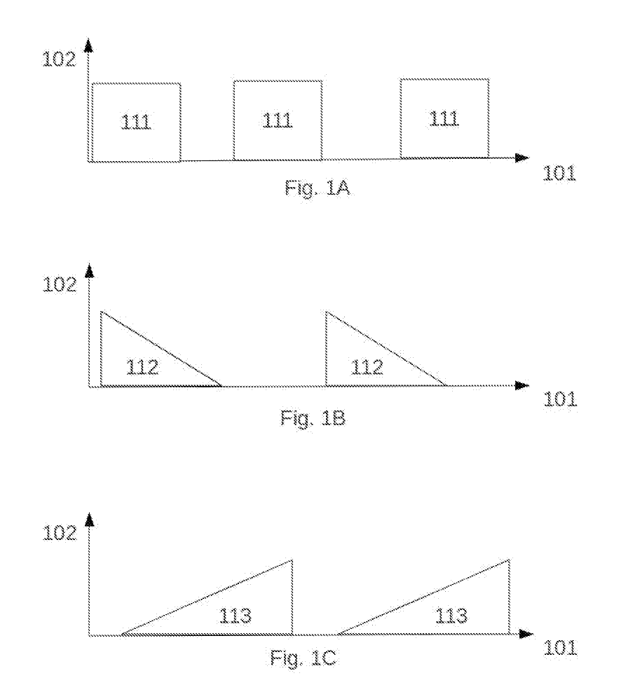

In FIG. 1A data flow (111) is either on or off. If it is on it is at a constant rate.

In FIG. 1B data flow (112) starts high, ramps down, goes to zero, and then stops for a while. Then the process repeats.

In FIG. 1C data flow (113) starts at 0, ramps up to a point, and then goes back to zero for a while. Then the process repeats.

### EMBODIMENTS

System Power Consumption Estimation Method

In an embodiment a method to simulation the power consumption of a system, called the system power consumption estimation method, comprises the following steps:
1. For each sub-block of the system the method characterizes the power consumption of that sub block by some method called the block power consumption estimation method. The block power consumption method results in a block-level characterization of the average power consumption of that block as a function of its input control signals.
2. Once each sub-block has been characterized a method called the system simulation method simulates the system. This takes a sequence of input vectors and feeds in the control portions of these vectors to the sub-blocks in the system, as function of how these sub-blocks connect.

The control inputs for each block, plus the power consumption characterization as a function of control inputs from step 1, determine the power consumption for that block.
3. The estimate of power consumption of the system over the duration of an input vector is the sum of all the estimates of power consumption for the sub-blocks in the system.
4. Overall the estimation of power consumption of the system over the duration of simulation is the sum of all the estimates of power consumption of the system over time.

Block Power Consumption Estimation Method

In an embodiment the block power consumption estimation method may function in various ways.
In some embodiments this is done by mathematically calculating how much power the block uses based on some description of the composition of the block.
In some embodiments this is done by simulating the element and seeing what the simulation estimates power consumption to be for the element.
In some embodiments this is done by empirically driving the input vector of the stimulus into a real implementation of the system element and determining how much power the system element uses.
In some embodiments this is done some other way.

In some embodiments the system characterizes power consumption by using all control signals. In some embodiments the system characterizes power consumption by using some control signals. In some embodiments the system uses different control signals at different times to model power consumption.

### EXAMPLE EMBODIMENT

In an embodiment the control state determines whether the data flow is on-and-off as shown in FIG. 1, or ramps down and stays at zero as in FIG. 2, or ramps up from zero to a certain point, then goes back to 0 for a while. For this embodiment the Block Power Consumption Estimation Method determines which configurations of the control signals cause which of these cases, and saves this characterization. Then the System Power Consumption Estimation Method runs a simulation. During the course of the simulation the control signals determine which of these cases—FIG. 1A, FIG. 1B or FIG. 1C—is the current case, and estimates power consumption from this.

### Other Embodiments

I show these varied and numerous embodiments of the invention to be exemplary and in no way limiting. Many other embodiments are possible, without departing from the spirit of the invention or sacrificing its advantages.

### CONCLUSIONS

The methods presented here will benefit designers in that they will be able to estimate power consumption more readily than they do today. This in turn will lead to faster design cycles, and lower the cost of building a system overall.

I claim:

1. A method for estimating the power consumption of a digital computational or digital electromechanical system which comprises the following steps:
a) for each sub-block of said system, separate input signals into control and data signals;
b) for each sub-block of said system, characterize said sub-block by determining for each possible set of values for some subset of only said control signals, this subset possibly being all said control signals, and no data signals, estimate an average power consumption over all possible data signals;
c) simulate said system with a sequence of input vectors comprising control and data signals where for each input vector;
<i> each set of said signals results in each said sub-block receives receiving the proper input control signal values;
<ii> each said sub-block looks up in its said characterization, a power consumption estimate based on said input control signal values;
<iii> said simulation calculates overall a system power consumption estimate for said system with said input vector, by summing said power consumption estimates of each said sub-block;
thereby estimating overall power consumption of said system during said simulation for a given input vector;
the improvement being using only said control signals for power estimation instead of both control and data signals, thereby reducing simulation complexity and duration.
